(19) United States
(12) Patent Application Publication
(10) Pub. No.: US 2021/0337893 A1
(43) Pub. Date: Nov. 4, 2021

(54) Filtered Nose Cover

(71) Applicant: Wayne Williams, Bethlehem, PA (US)

(72) Inventor: Wayne Williams, Bethlehem, PA (US)

(21) Appl. No.: 17/019,444

(22) Filed: Sep. 14, 2020

Related U.S. Application Data
(60) Provisional application No. 63/017,803, filed on Apr. 30, 2020.

(51) Int. Cl. A41D 13/11; A62B 23/06

(52) U.S. Cl. CPC A41D 13/1107; A62B 23/06; A41D 13/1161

(57) ABSTRACT

A nose cover of embodiments of the disclosed technology has two portals sized to removably hold air filters. The portals may be located, in various embodiments, on opposite sides of the nose cover, or may be placed adjacent to one another on a bottom side of the nose cover. The nose cover is sized and shaped to fit over a nose of an anticipated user in a substantially airtight way, such that air can only pass between an area exterior of the nose cover and an area interior of the nose cover by way of the air filters in the portals.

### FIELD OF THE DISCLOSED TECHNOLOGY

The disclosed technology relates generally to a personal air filter, and more specifically to a nose cover adapted to and/or designed to filter air.

### BACKGROUND

In recent years, there has been a growing demand for methods by which people may filter the air that they breathe in order to keep from inhaling dust, germs, and other invisible particles. One common method for such filtration has been through the use of masks. These masks, however, tend to be cumbersome, preventing clear speech and the use of facial expressions in communication, as well as being unusable when eating or drinking. Furthermore, these masks are often unsized, and thus do not create a tight and secure seal which allows only filtered air to be inhaled.

Thus, there is a need for a wearable filtration system which does not hinder use of the mouth while providing a reliable source of filtered air for inhalation. This and other problems are solved by embodiments of the disclosed technology, as described below.

### SUMMARY OF THE DISCLOSED TECHNOLOGY

A nose cover of embodiments of the disclosed technology has an exterior cover with an interior side in a shape of a human nose. It further has two portals, each portal thereof between the interior side of the exterior cover, and filters. At least one of each respective filter is disposed within each respective portal. An elasticized band is attached to either side of the interior and/or the exterior cover and is adapted to and/or designed to and/or designed to hold the nose cover to a nose of a wearer and to be positioned around ears of a wearer. Each of the filters has an air passage from the exterior cover to the interior side of the nose cover.

“Air passage” is defined as a path where air flows with less resistance than surroundings thereof, the passage being circumscribed by an area blocking air flow. “Interior” is defined as “a generally concave region of the nose cover and/or an area circumscribed by the cover and/or a space between the nose cover and a nose of a wearer.” “Exterior” is defined as “a generally convex region of the nose cover and/or a side opposite an area circumscribed by the cover and/or a side opposite the interior side.”

In some embodiments, the shape of a human nose of the nose cover further has a bridge extending outwardly from, and at an acute angle, relative to a posterior side of the nose cover, as well as two oppositely disposed pieces extending from along the bridge towards the posterior side. It also has, in some embodiments, a bottom section extending towards the posterior side at a substantially perpendicular angle to the bridge and forming a unitary structure with each respective bottom edge of the two oppositely disposed pieces and an end of the bridge which is furthest from the face. In embodiments, the two portals are within the bottom section or are each in an oppositely disposed side of the two oppositely disposed sides. It should be understood that when discussing parts of a nose or face with reference to the nose cover, these are equivalent parts of the nose cover which are designed to mimic and/or look like such parts of a human nose or face. “Equivalent” is defined as “corresponding to.”

“Posterior” is defined as a direction opposite that of a tip of a nose and/or side adapted to, and designed to be placed against a face to cover a nose.

The cover, in various embodiments, is adapted to cover, and/or be designed to be in simultaneous contact with a dorsum, tip, wings, and nostrils of the nose of an anticipated user of the nose cover.

Each portal of the two portals is adapted to and/or designed to removably and/or replaceably hold one of the filters, in embodiments of the disclosed technology. Furthermore, each portal of the two portals, in some embodiments, is within the bottom section of the nose cover. In some embodiments, each portal of the two portals is substantially aligned with the nostrils of the nose of the anticipated user. The filter within the portal, in some embodiments, extends upwards from outside of the nose cover to an interior space within the nose cover.

“Aligned with” is defined as being positioned such that substantially every point of an edge of the portal has a point of an edge of a respective nostril such that substantially every distance between a point on the edge of the portal and a corresponding point on the edge of the nostril has a substantially equal length between them.

The nose cover, in some embodiments, is made of a material which is pliable and bendable and which returns to its original shape when deformed. In embodiments, the filters are cylindrical.

“Pliable” is defined as “able to receive sheer forces while remaining structurally intact”, “bendable” is defined as “able to change a shape thereof with one's hands”, and “resilient” is defined as “returns to its original shape after being deformed” each of which is, in some embodiments of the disclosed technology, after being bent and/or deformed 100 times by bare-handed human force.

A method of wearing the above-disclosed nose cover, in some embodiments, has the steps of, in any order: placing the exterior cover with interior side over the anticipated user's nose, securing the exterior cover by way of putting in place and adjusting the elasticized band, and inserting into each of the portals a respective air filter.

In some embodiments, the method has the further steps of removing an air filter from at least one of the portals and replacing the removed air filter with a new air filter.

In embodiments, the elasticized band, when secured, exerts pressure on the exterior cover such that the exterior cover is pulled towards the anticipated user's face and towards the anticipated user's nose, preventing or hindering lateral and/or vertical movement of the exterior cover and holding a filter which passes through the nose cover in a manner such that removal of the filter is prevented while the nose cover is against a face and/or nose of a wearer. In some embodiments, a filter can only be removed though the concave/posterior side of the nose cover.

The external cover is shaped, in various embodiments, such that when the external cover is in simultaneous contact with a dorsum, a tip, wings, and nostrils of the anticipated user's nose, the cover presses skin towards lateral cartilage, major alar cartilage, and lesser alar cartilage of the anticipated user's nose.

“Anticipated user” is defined as “a person, or people in general” any of which may use the nose cover and breathe through the filters.

A molded piece of pliable and resilient material of embodiments of the disclosed technology has an elasticized band and two separate portals. Each portal has an air passageway through the molded piece and is disposed adjacent to the other portal, and the two separate portals are disposed adjacent to an edge of the molded piece. It further has two filters, each filter adapted to and/or designed to be removably placed within each respective portal. Each filter of the two filters comprises an air passageway.

A molded piece of embodiments of the disclosed technology has an elasticized band, two separate portals, and two filters. Each filter is adapted to and/or designed to be removably placed within each respective portal. The molded piece further has a single most-extruded peak and a most-horizontal piece extending from the peak to an edge adjacent to the separate portals. Two oppositely-disposed angled pieces extend from the peak to the oppositely-disposed sides, which are attached to two extreme opposite ends of the elasticized band. Additionally, a most-angled piece extends from the peak to an edge disposed substantially inline with and furthest from a center of the edge adjacent to the separate portals. Each filter of the two filters has an air passageway.

“Most horizontal” is defined as being least angled away from the horizontal plane when the molded piece is substantially covering a nose. “Most angled” is defined as being most angled away from the horizontal plane when the molded piece is rested.

The molded piece, in embodiments, is sized and shaped to fit over a nose of an anticipated user. In further embodiments, the single most-extruded peak is adapted to and/or designed to fit over a tip of the nose of the anticipated user, and the most-horizontal piece is adapted to and/or designed to fit over and around nostrils and a columella of the nose of the anticipated user. Each respective piece of the two oppositely-disposed angled pieces is adapted to and/or designed to fit over a respective sidewall of the nose of the anticipated user, and the most-angled piece is adapted to and/or designed to fit over a dorsum of the nose of the anticipated user. Each portal of the two separate portals is adapted to and/or designed to align with a respective nostril of the nose of the anticipated user, such that a continuous air passage exists between an exterior edge of a portal of the two separate portals and a respective nostril.

“Fit over” is defined as “substantially cover, with or without making full or partial contact with any part of the thing being covered”.

Furthermore, in some embodiments, each filter of the two filters is sized and shaped to completely fill each respective portal, such that all air passing through the portal simultaneously passes through the filter.

It should be understood that for purposes of convenience of this disclosure, “top” and “bottom” refer to one orientation of wearing the nose cover when a person wearing the device is standing while looking forward along a horizontal plane relative to a (flat) ground. Likewise, other directional indicators are relative to such a person and/or person's face.

Any device or step to a method described in this disclosure can comprise or consist of that which it is a part of, or the parts which make up the device or step. The term “and/or” is inclusive of the items which it joins linguistically and each item by itself.

### BRIEF DESCRIPTION OF THE DRAWINGS

FIG. 1 shows a top and right perspective view of a nose cover of embodiments of the disclosed technology on an anticipated user's head and face.

FIG. 2 shows a right side elevation view of the nose cover of FIG. 1 on an anticipated user's head and face.

FIG. 3 shows a front elevation view of the nose cover of FIG. 1 on an anticipated user's head and face.

FIG. 4 shows a top and right perspective view of the nose cover of FIG. 1.

FIG. 5 shows a close-up exploded top right perspective view of the nose cover of FIG. 1.

FIG. 6 shows a close-up exploded back right perspective view of the nose cover of FIG. 1.

FIG. 7 shows a right side elevation view of a nose cover with inverted filters of another embodiment of the disclosed technology.

FIG. 8 shows a close-up back right perspective view of the nose cover of FIG. 7.

FIG. 9 shows a close-up bottom right perspective view of the nose cover of FIG. 7.

FIG. 10 shows a right side elevation view of a nose cover with detachable filtration unit of embodiments of the disclosed technology.

FIG. 11 shows a close-up back right perspective view of the nose cover of FIG. 10.

FIG. 12 shows a close-up bottom right perspective view of the nose cover of FIG. 10.

FIG. 13 shows a front elevation view of a nose filter of embodiments of the disclosed technology on an anticipated user's face.

FIG. 14 shows a close-up exploded front elevation view of the nose filter of FIG. 13.

FIG. 15 shows a vertical cross-section view of a nose filter of FIG. 14.

### DETAILED DESCRIPTION OF EMBODIMENTS OF THE DISCLOSED TECHNOLOGY

A nose cover of embodiments of the disclosed technology has two portals sized to removably hold air filters. The portals may be located, in various embodiments, on opposite sides of the nose cover, or may be placed adjacent to one another on a bottom side of the nose cover. The nose cover is sized and shaped to fit over a nose of an anticipated user in a substantially airtight way, such that air can only pass between an area exterior of the nose cover and an area interior of the nose cover by way of the air filters in the portals.

Embodiments of the disclosed technology will become more clear in view of the following discussion of the figures.

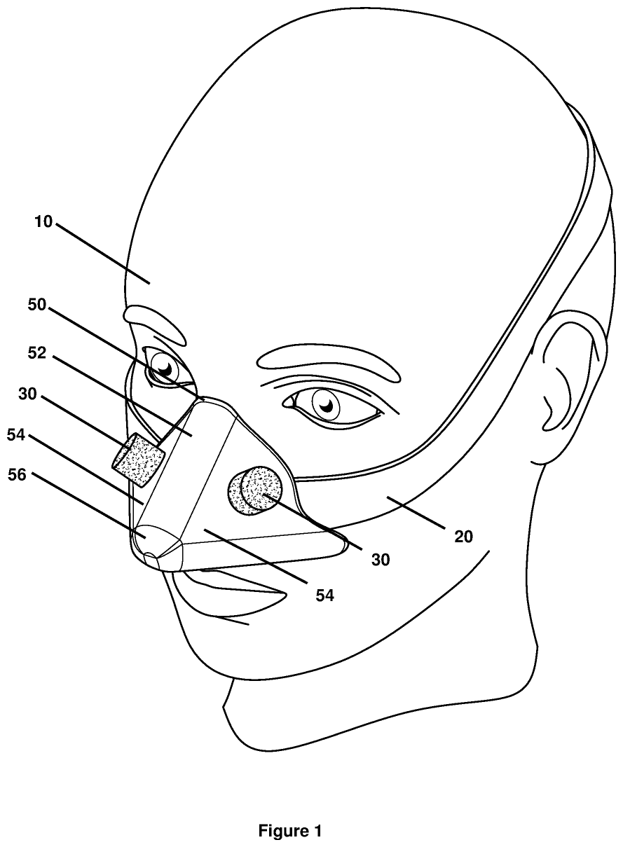

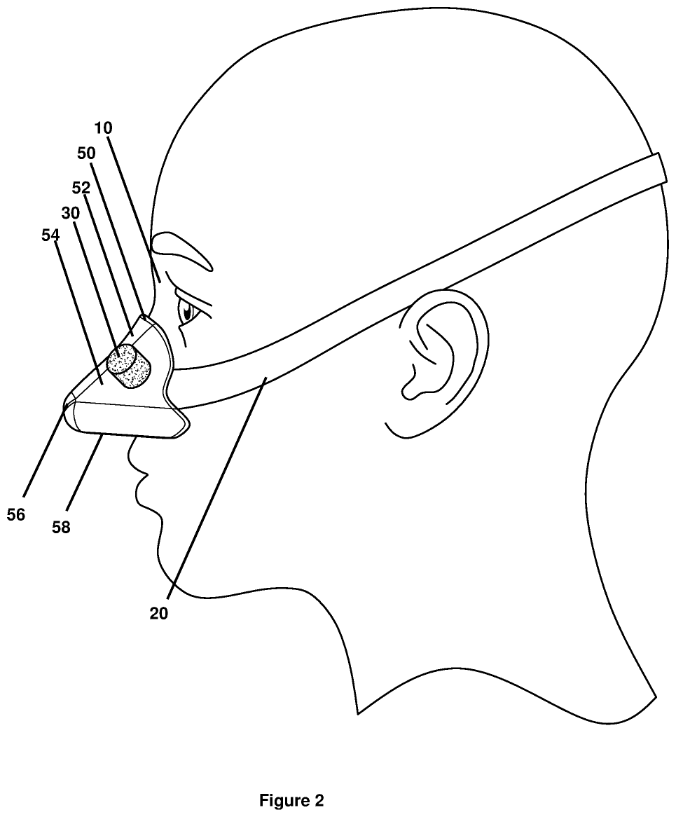

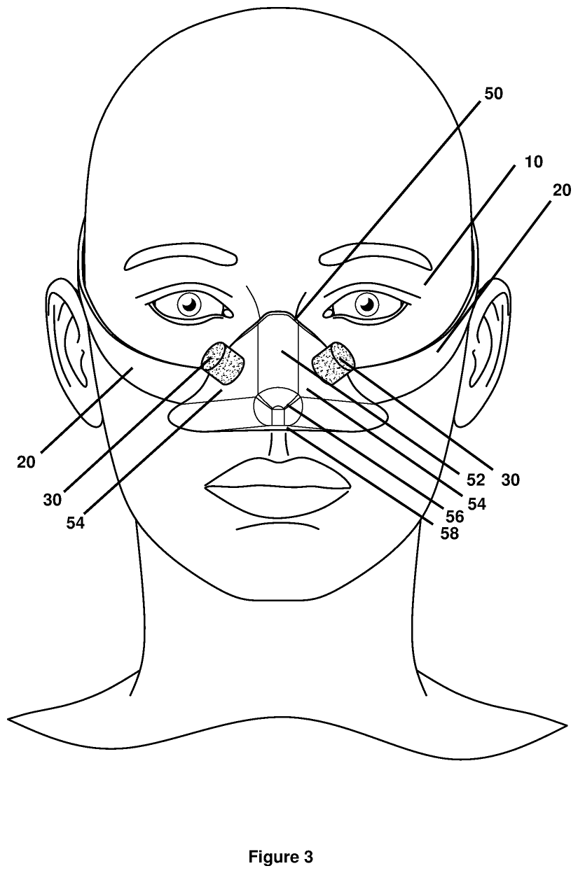

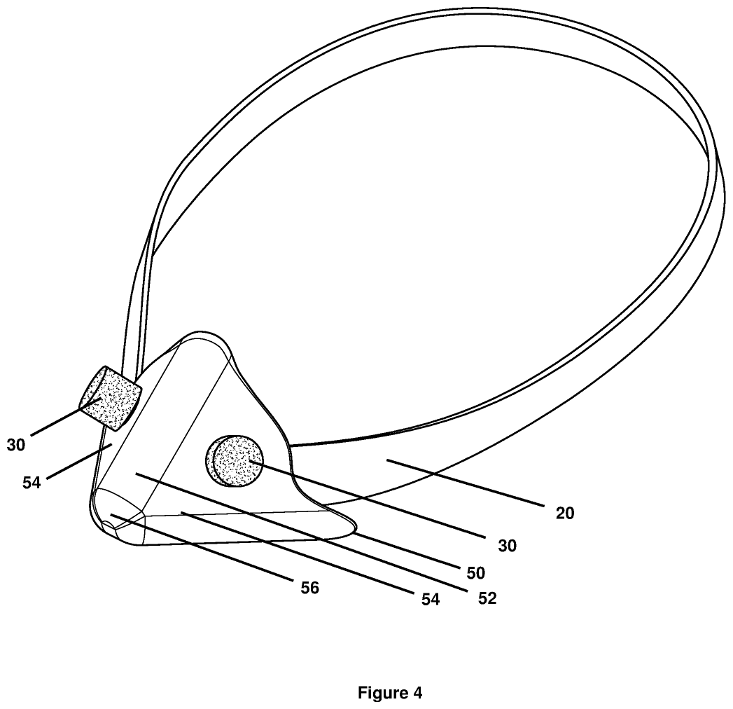

Discussing first FIGS. 1 through 4, FIG. 1 shows a top and right perspective view of a nose cover of embodiments of the disclosed technology on an anticipated user's head and face. FIG. 2 shows a right side elevation view of the nose cover of FIG. 1 on an anticipated user's head and face. FIG. 3 shows a front elevation view of the nose cover of FIG. 1 on an anticipated user's head and face. FIG. 4 shows a top and right perspective view of the nose cover of FIG. 1. The nose cover 50 further has a tip 56 from which extends into a bridge 52, a bottom side 58, and two sides 54. These sides form a substantially unitary structure save for two portals 40 (not shown in these Figures) in which filters 30 are removably inserted.

In these Figures, the portals 40 with the inserted filters 30 are shown to be disposed substantially oppositely in the sides 54 of the nose cover 50. In other embodiments, the portals 40 with the inserted filters 30 may be disposed in another part and/or parts of the nose cover 50, such as the bridge 52 or the bottom side 58. In another embodiment, there may be only one portal 40 with one inserted filter 30, or there may be more than two portals 30 with inserted filter 40.

An elasticized band 20 is connected on opposite extreme ends to edges the two sides 54 and extends around the back of the head of the anticipated user to secure the nose cover 50. In various other embodiments, the band 20 may be made of a non-elastic material, and may instead have a tie, strap, buckle, and/or velcro connection/connections. In other embodiments, there may be more than one parallel band 20 extending around, above, and/or below the anticipated user's head. The band 20 may be, in further embodiments, two or more straps meant to secure the nose cover 50 around the ears rather than around the head. In other embodiments, the nose cover 50 may be secured with both head and ear bands 20.

The nose cover 50 is pulled against the face 10 of the anticipated user such that it covers the anticipated user's nose and creates a substantially airtight seal so that air can only enter the anticipated user's nose by way of the air filters 30 in the portals 40.

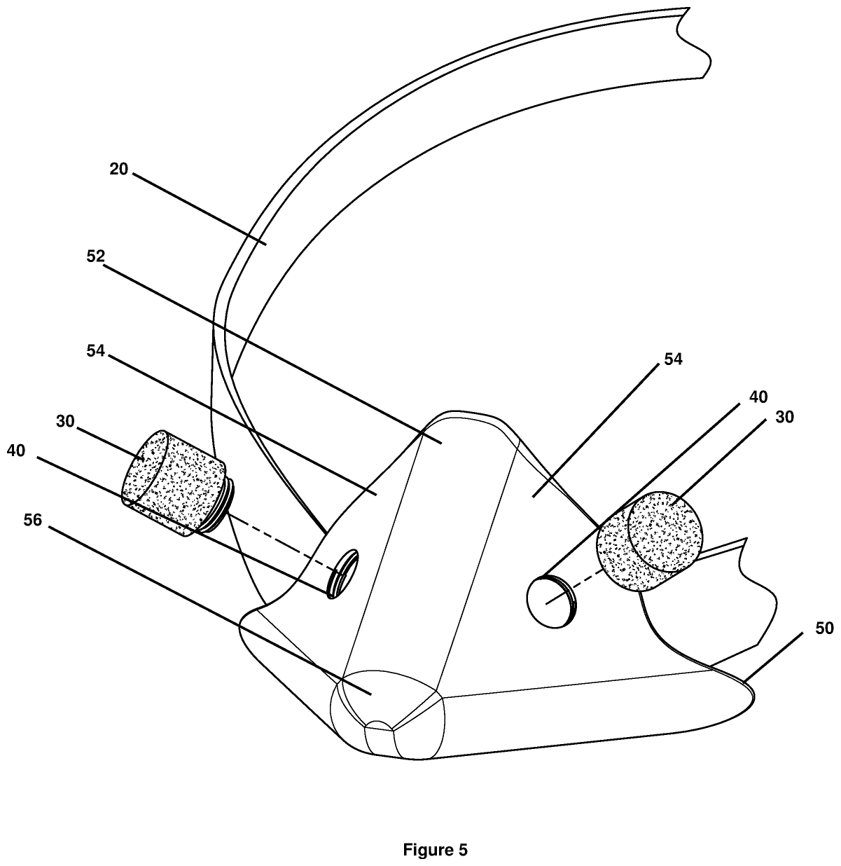

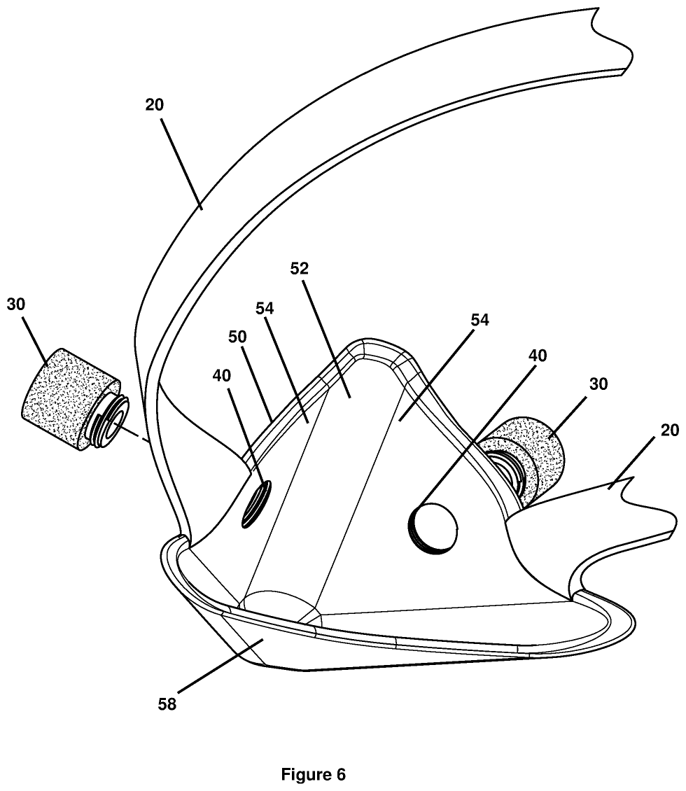

Now discussing FIGS. 5 and 6, FIG. 5 shows a close-up exploded top right perspective view of the nose cover of FIG. 1. FIG. 6 shows a close-up exploded back right perspective view of the nose cover of FIG. 1. As can be seen in these Figures, the filters 30 are removably insertable into the portals 40. The filters 30, in this embodiment, extend outwards from the mask body 50. The portals 40 and filters 30 may be threaded so that the filters 30 can be secured by being screwed into place. In other embodiments, the portals 20 may be sized such that the filters 30 are frictionally held in place. Other methods of securing the filters 30 within the portals 40 may be used aside from or in addition to these.

Additionally, these Figures show that the elasticized band 20 is connected to the nose cover 50 at and/or near a bottom part of an edge of the sides 54 of the nose cover 50. In other embodiments, the connection may be at a different point along the edge of the nose cover 50. Furthermore, the band 20 may become wider or thinner at the connection and/or may split into two or more branches, each of which is connected separately to the edge of the nose cover 50. In embodiments, the connection may be located within the nose cover 50 rather than at its edge. The band 20 may, in some embodiments, have a branch which extends over the head of the anticipated user and connects to an edge of the bridge 52 of the nose cover.

In the embodiment shown in these Figures, an airflow exists in which air passes through one of the air filters 30 and a respective portal 40 to enter an interior space of the nose cover 50, where it may be inhaled through one or both of the nostrils 64. Air exhaled from the nostrils follows the same pathway in reverse.

FIG. 7 shows a right side elevation view of a nose cover with inverted filters of other embodiments of the disclosed technology on an anticipated user's head and face. In this embodiment, the portals 40 are located on the bottom side 58 and each portal 40 is aligned with a nostril 64 of the nose 60 of the anticipated user. Each filter 30 extends inward from the respective portal 40 and into the respective nostril 64 rather than extending outward. In other embodiments, each filter 30 extends inward from the respective portal 40 into an area just in front of the respective nostril 64 rather than entering into the respective nostril 64. In further embodiments, each filter 30 extends inward from the respective portal 40 into an area partially or wholly surrounding the respective nostril 64.

As shown by this Figure, the nose cover 50 is sized and shaped to cover the nose 60 of the anticipated user, including wholly or partially covering a bridge and/or dorsum 70, a tip 62, a pair of wings 68, a columella 66, and a pair of nostrils 64. The nose cover 50 also covers, in this embodiment, nose cartilages including but not limited to major alar cartilage 72, lesser alar cartilage 76, and lateral cartilage 78. In various embodiments, the nose cover 50 may be pulled by the elasticized band 20 such that the nose cover presses against any or all of these various body parts.

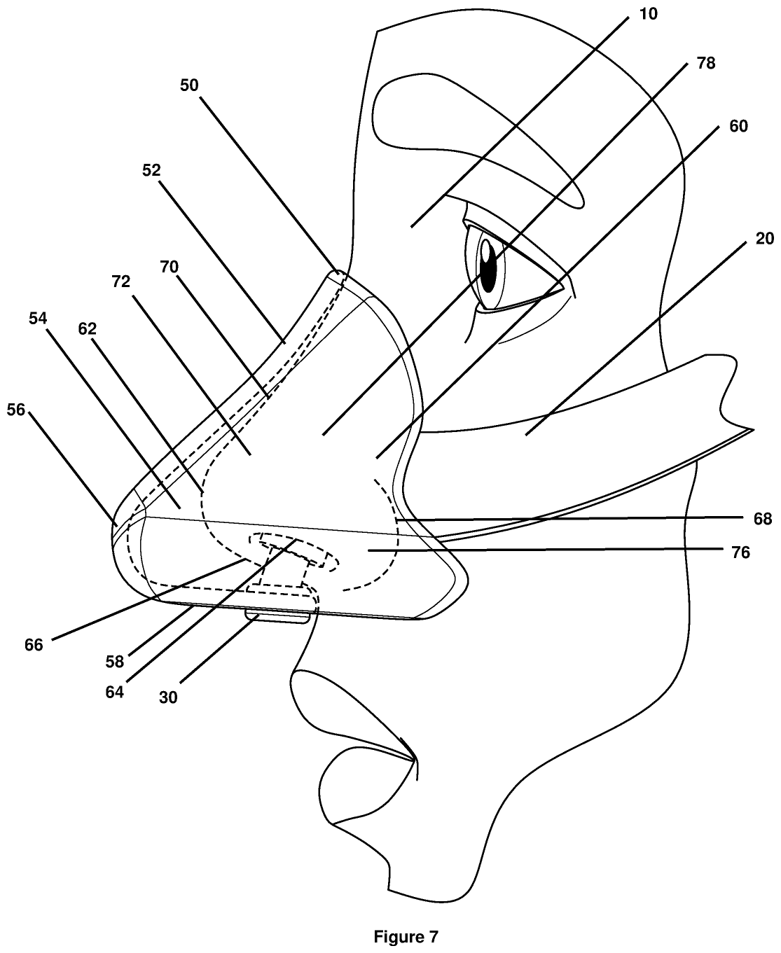

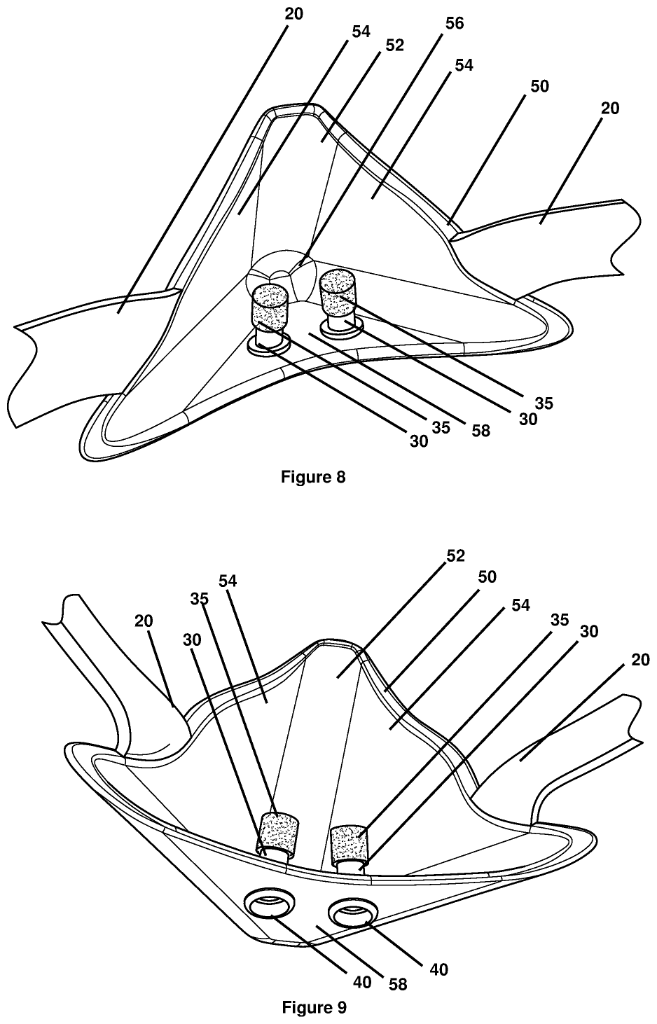

FIG. 8 shows a close-up back right perspective view of the nose cover of FIG. 7. FIG. 9 shows a close-up bottom right perspective view of the nose cover of FIG. 7. As can be seen in these Figures, the filters 30 of this embodiment extend inward and at an angle from the portals 40. Additionally, the filters 30, in this embodiment, have an end which contains a filtration unit 35. In other embodiments, the entire filter 30 is simultaneously the filtration unit 35. In this embodiment, the filter 30 is removably attached to the portal 40. In various embodiments, the filtration unit 35 may be removably attached to the filter 30 and/or may form a unitary structure with the filter 30. The filtration unit 35, in this embodiment, extends partially or wholly into the nostril 64 of the anticipated user, while an end of the filter 30 unencumbered by the filtration unit 35 is secured within the portal 40.

In the embodiment shown in these Figures, an airflow exists in which air passes through one of the portals 40 to enter a respective air filter 30 followed by a respective filtration unit 35 and a respective nostril 64. Air exhaled from the nostrils follows the same pathway in reverse.

In some embodiments, the filters 30 may be positioned within the portals 40 and within an interior space of the nose cover 50 such that at least one of the filters 30 and/or the filtration units 35 cannot be removed while the nose cover 50 is being worn, i.e. when the nose cover is against a face 10 and/or nose 60 of a wearer.

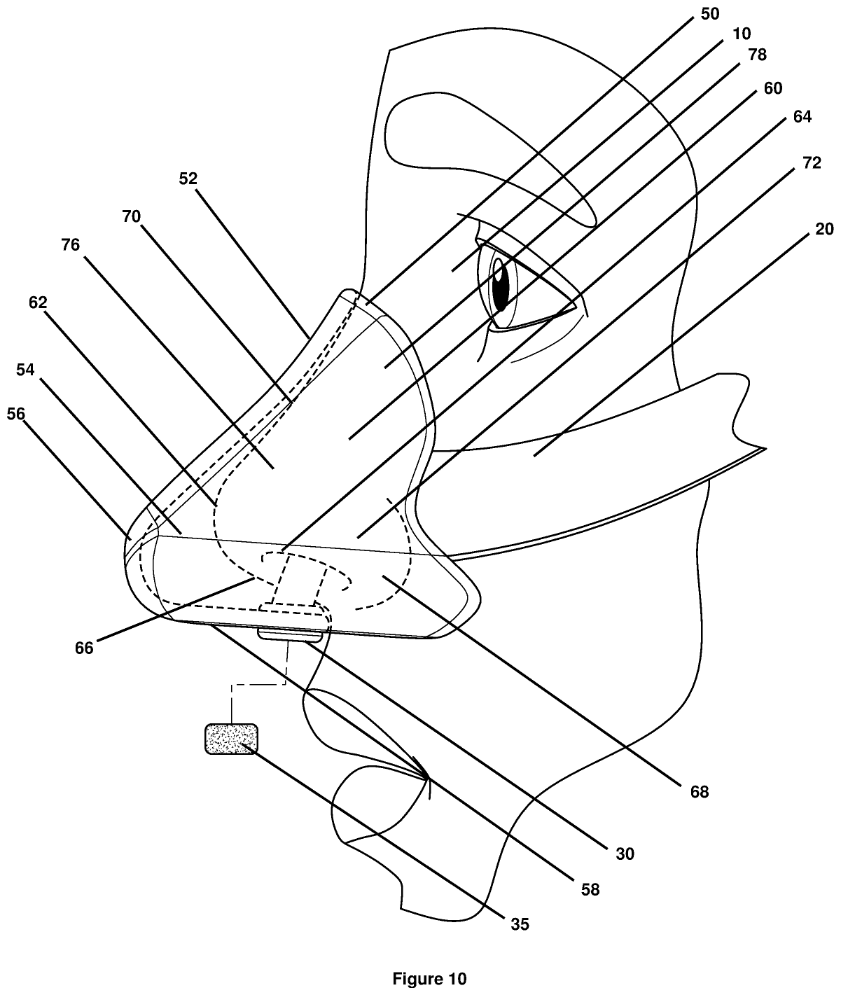

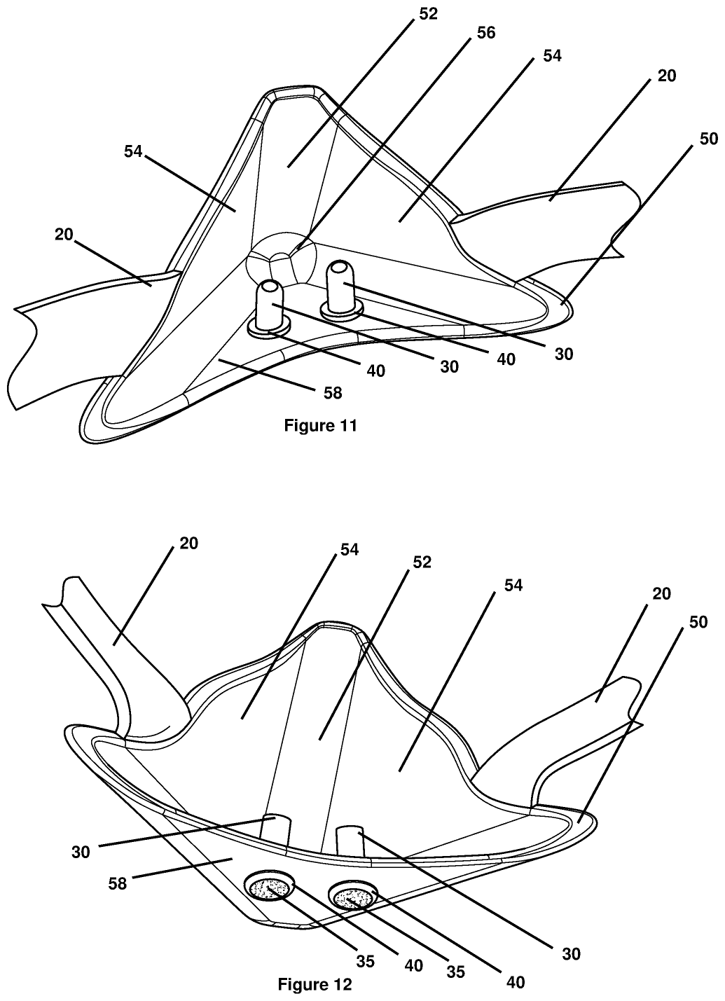

FIG. 10 shows a right side elevation view of a nose cover with detachable filtration unit of other embodiments of the disclosed technology on an anticipated user's head and face. FIG. 11 shows a close-up back right perspective view of the nose cover of FIG. 10. FIG. 12 shows a close-up bottom right perspective view of the nose cover of FIG. 10. In this embodiment, an end of the filter 30 which is attached to the filtration unit 35 is secured within the portal 40, while an end of the filter 30 unencumbered by the filtration unit 35 extends partially or wholly into a nostril 64 of the anticipated user. In various embodiments, the filters 30 may be removably attached to the portals 40 and the filtration units 35 may be removably attached to the filters 30.

In the embodiment shown in these Figures, an airflow exists in which air passes through one of the filtration units 35 located in a respective portal 40 to enter a respective air filter 30 followed by a respective nostril 64. Air exhaled from the nostrils follows the same pathway in reverse.

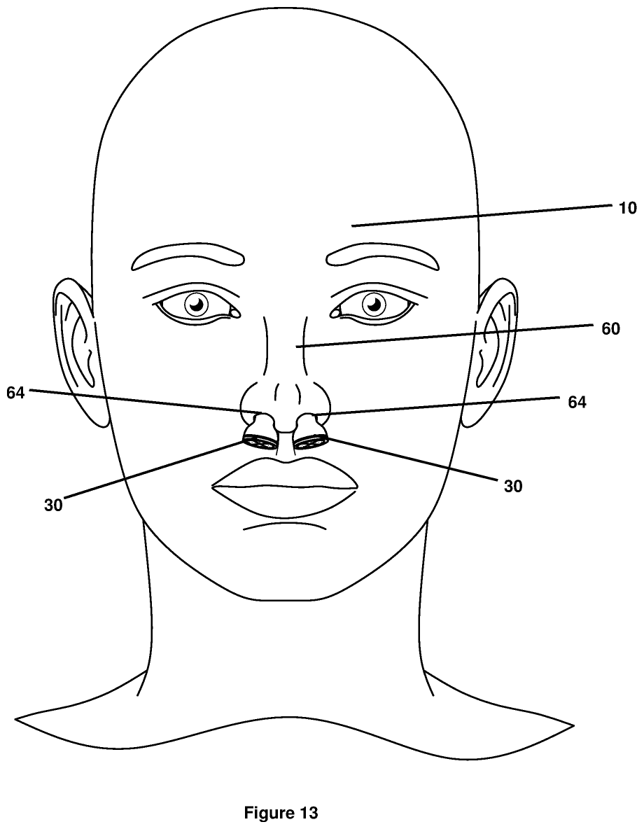

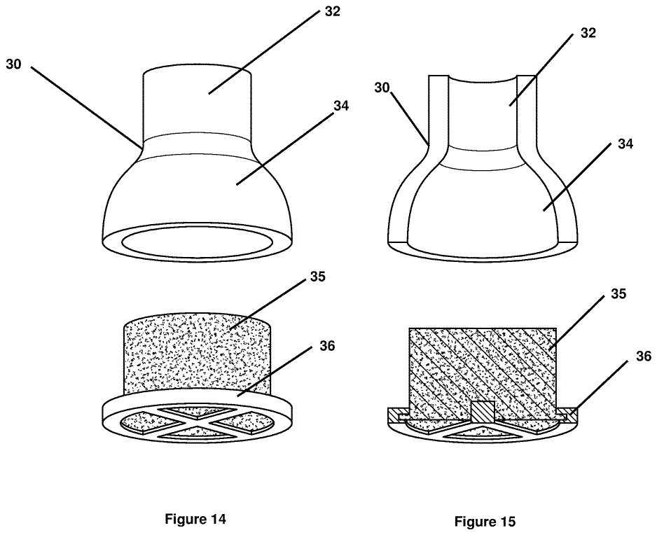

FIG. 13 shows a front elevation view of a nose filter of embodiments of the disclosed technology on an anticipated user's face. FIG. 14 shows a close-up exploded front elevation view of the nose filter of FIG. 13. FIG. 15 shows a cross-sectional close-up exploded front elevation view of a nose filter of FIG. 13. As shown by the Figures, in this embodiment, the filters 30 have a narrower portion 32 and a wider portion 34. Both sections, in embodiments, are hollow. The narrower portion 32 may be adapted to and/or designed to be inserted into a nostril 64 of an anticipated user, and the wider portion 34 may be adapted to and/or designed to hold a filtration unit 35. An external guard section 36 may be placed at an external opening of the wider portion 34.

In various embodiments, the filter 30 may be of a single, uniform width and have an end adapted to and/or designed to hold the filtration unit 35 inside thereof. In other embodiments, the filter 30 may have an end adapted to and/or designed to fit inside an opening within the filtration unit 35. The filter 30 may have two or more filtration units 35 at either end, and/or may have a filtration unit 35 inserted between the ends thereof. A portion and/or an entirety of the filter 30 may simultaneously be the filtration unit 35 and/or may form a unitary structure with the filtration unit 35. In other embodiments, the filtration unit and/or units 35 may be removably connected to the filter 30 by means including, but not limited to, friction or screwing.

An end of the filter 30, alone or with an attached filtration unit 35, may be sized to substantially fill at least one cross-section of the portal 40.

For purposes of this disclosure, the term “substantially” is defined as “at least 95% of the term which it modifies”. “Generally” is defined as being “as an ordinary observer would consider to be so”.

Any device or aspect of the technology can “comprise” or “consist of” the item it modifies, whether explicitly written as such or otherwise.

When the term “or” is used, it creates a group which has within either term being connected by the conjunction as well as both terms being connected by the conjunction.

While the disclosed technology has been disclosed with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1. A nose cover comprising:
an exterior cover with an interior side in a shape of a human nose;
two portals, each portal thereof between said interior side of said exterior cover;
filters, at least one of each respective said filter being disposed within each respective said portal;
an elasticized band attached to either side of said interior and/or said exterior cover designed to hold said nose cover to a nose of a wearer and said band around ears of a wearer;
wherein each of said filters comprises an air passage from said exterior cover and to said interior side of said nose cover.

2. The nose cover of claim 1, wherein said shape of a human nose of said nose cover further comprises:
a bridge extending outwardly from, and at an acute angle, relative to a posterior side of said nose cover;
two oppositely disposed pieces extending from along said bridge towards said posterior side; and
a bottom section extending towards said posterior side at a substantially perpendicular angle to said bridge and forming a unitary structure with each respective bottom edge of said two oppositely disposed pieces and an end of said bridge which is furthest from said face;
wherein said two portals are within said bottom section or each in an oppositely disposed side of said two oppositely disposed sides.

3. The nose cover of claim 1, wherein said cover is designed to cover and be in simultaneous contact with a dorsum, tip, wings, and nostrils of said nose of an anticipated user of said nose cover.

4. The nose cover of claim 1, wherein each portal of said two portals is designed to removably and/or replaceably hold one of said filters.

5. The nose cover of claim 2, wherein each portal of said two portals is within said bottom section of said nose cover.

6. The nose cover of claim 1, wherein each said portal of said two portals is substantially aligned with said nostrils of said nose of said anticipated user.

7. The nose cover of claim 6, wherein said filter within said portal extends upwards from outside of said nose cover to an interior space within said nose cover.

8. The nose cover of claim 1, wherein said cover is made of a material which is pliable and bendable and which returns to its original shape when deformed.

9. The nose cover of claim 1, wherein said filters are cylindrical.

10. A method of wearing said nose cover of claim 1, comprising the steps of, in any order:
placing said exterior cover with interior side over said anticipated user's nose;
securing said exterior cover by way of putting in place and adjusting said elasticized band; and
inserting into each of said portals a respective air filter.

11. The method of claim 10, further comprising the steps of:
removing an air filter from at least one of said portals; and
replacing said removed air filter with a new air filter.

12. The method of claim 10, wherein said elasticized band, when secured, exerts pressure on said exterior cover such that said exterior cover is pulled towards said anticipated user's face and towards said anticipated user's nose, preventing or hindering lateral and/or vertical movement of said exterior cover and preventing removal of at least one air filter while said exterior cover is against a face and/or nose of a wearer.

13. The method of claim 10, wherein said external cover is shaped such that when said external cover is in simultaneous contact with a dorsum, a tip, wings, and nostrils of said anticipated user's nose, said cover presses skin towards lateral cartilage, major alar cartilage, and lesser alar cartilage of said anticipated user's nose.

14. A molded piece of pliable and resilient material comprising:
an elasticized band;
two separate portals, each said portal comprising an air passageway through said molded piece, each said portal disposed adjacent to said other portal and said two separate portals disposed adjacent to an edge of said molded piece; and
two filters, each said filter designed to be removably placed within each respective portal;
wherein each said filter of said two filters comprises an air passageway.

15. A molded piece comprising:
an elasticized band;
two separate portals;
two filters, each said filter designed to be removably placed within each respective portal;
a single most-extruded peak;
a most-horizontal piece extending from said peak to an edge adjacent to said separate portals;
two oppositely-disposed angled pieces extending from said peak to said oppositely-disposed sides attached to said two extreme opposite ends of said elasticized band;
a most-angled piece extending from said peak to an edge disposed substantially inline with and furthest from a center of said edge adjacent to said separate portals;
wherein each said filter of said two filters comprises an air passageway.

16. The molded piece of claim 15, wherein said molded piece is sized and shaped to fit over a nose of an anticipated user.

17. The molded piece of claim 16, wherein
said single most-extruded peak is designed to fit over a tip of said nose of said anticipated user;
said most-horizontal piece is designed to fit over and around nostrils and a columella of said nose of said anticipated user;
each respective piece of said two oppositely-disposed angled pieces is designed to fit over a respective sidewall of said nose of said anticipated user;
said most-angled piece is designed to fit over a dorsum of said nose of said anticipated user; and
each portal of said two separate portals is designed to align with a respective nostril of said nose of said anticipated user, such that a continuous air passage exists between an exterior edge of a portal of said two separate portals and a respective nostril.

18. The molded piece of claim 15, wherein each said filter of said two filters is sized and shaped to completely fill each respective portal, such that all air passing through said portal simultaneously passes through said filter.

19. (canceled)
